(19) United States
(12) Patent Application Publication
(10) Pub. No.: US 2015/0178028 A1
(43) Pub. Date: Jun. 25, 2015

(54) METHOD AND DEVICE FOR CONTROLLING AND REGULATING A DIGITAL PRINTING PROCESS

(71) Applicant: manroland web systems GmbH, Augsburg (DE)

(72) Inventor: Andreas ELCHLEPP, Aichach (DE)

(73) Assignee: manroland web systems GmbH, Augsburg (DE)

(21) Appl. No.: 14/577,424

(22) Filed: Dec. 19, 2014

(30) Foreign Application Priority Data
Dec. 20, 2013 (DE) 10 2013 021 736.9

(51) Int. Cl. G06F 3/12

(52) U.S. Cl. CPC G06F 3/1243; G06F 3/1282; G06F 3/1206; G06F 3/1251; G06F 3/1252

(57) ABSTRACT

A method for the control or regulation of a production process in a print form-variable production device is disclosed, where the production process includes one or multiple orders and where for each of these orders corresponding product data are stored in a storage device. In an embodiment, the method includes the following steps: a. scanning a print image by a scanning device of at least one part of a substrate to produce a scanned print image; b. comparing the scanned print image with the product data stored for each of the orders and assigning an associated order and associated product data of the associated order to the scanned print image based on the comparing; c. determining subsequent control actions from the associated product data; and d. executing the subsequent control actions by the production device. A device is also disclosed to carry out the method.

This application claims the priority of German Patent Document No. DE 10 2013 021 736.9, filed Dec. 20, 2013, the disclosure of which is expressly incorporated by reference herein.

### BACKGROUND AND SUMMARY OF THE INVENTION

The invention relates to a method for controlling and regulating a production process in a print form-variable production device, and to a device for carrying out the method.

In print shops, production devices are employed that can carry out an order completely. This comprises the printing of the order and also further processing into the finished product, for example an advertising flyer consisting of a single sheet through to a completely bound book.

It can be noted that production devices are increasingly employed in which digital printing presses are used as a printing device, which compared with conventional offset printing presses are particularly suited for processing a plurality of changing and different printing orders, that is, in principle, can print each individual print copy differently since they regenerate the image with each individual printing operation. These production devices are called print form-variable devices or digital printing presses.

Already known from practice is that a digital printing press comprises a production planning and production control system, that is, for example, a digital print planning module and a printing press computer in order to plan and control the printing of printing orders on the digital printing press.

It is known, furthermore, that in a prepress stage, i.e., in a production stage preceding the actual machine printing operation, information that is required—namely so-called printing data—is already prepared matching to the preset machine printing conditions and the preset printing method and the area coverages and colours determined in a digital database accordingly. Based on this data the printing operation is then carried out in a printing press, such as, for example, an inkjet printing device or a laser printing device and during the print production these digital printing data are no longer changed. In digital printing presses, these data are digitally stored as digital printing data or imaging data and can be made available to the production device or accessed from the same throughout the production process.

It is known, furthermore, that the data of the so-called imposition known to the person skilled in the art can also be stored in the production planning and production control system in a format that is suitable for further processing.

It is known furthermore that a further processing device, for example a cutting, folding, gluing, punching, sectioning, collecting, separating-out and/or stitching device arranged downstream of the digital printing press has to be activated. This activation takes place by means of so-called “marks” up to now, which are printed onto the individual printing orders during the printing process, which are printed onto the so-called substrate. Here, a different “mark” is usually required for any action to be carried out by the further processing device.

This method has multiple disadvantages. On the one hand, more paper and ink is required for the space required for printing the mark since the part of the substrate containing the mark(s) has to be cut off since the customer does not want to have any mark on the finished product. Furthermore, the degree of automation of the production process is restricted since the further processing machine cannot be automatically linked to the data flow of the production planning and production control system. This means, among other things, that control actions such as, for example, cutting, collecting, folding, gluing, sectioning, perforating, separating, etc., cannot be carried out easily in the individual sequence for each order, i.e., without marks defined prior to the printing process and subsequently printed on, which can slow down the printing process. Furthermore, quality inspection by means of the marks is not possible.

An improvement of the degree of automation is proposed in a patent application submitted by the same applicant. However, the problem of the high paper and ink consumption is not solved here. Here, too, a rapid different control action for each order, i.e., a page-accurate control action, is not exposed as a problem or solved.

Solving the abovementioned problems is therefore an object of the present invention.

In an embodiment of the method according to the invention for controlling or regulating a production process in a print form-variable production device, wherein the production process comprises one or multiple orders, wherein for each of these orders suitable production data are stored in a storage device, the method comprises the following steps: a) scanning a print image of at least a part of a substrate by a scanning device, b) comparing the scanned print image with the product data stored for each order in order to assign the associated order and the associated product data to the scanned print image, c) comparing the scanned print image with the assigned product data in order to calculate subsequent control actions based on this comparison, and d) carrying out the control actions by the production device. The device according to the invention is adapted for this purpose to carry out the aforementioned method.

The core of the present invention is to make available a production process without the use of marks. An advantage of a production without marks is a subsequent saving of paper and ink, by way of which the production costs can be lowered and a more environmentally friendly method is made available. Furthermore, a higher degree of automation is achieved with such a method by providing product data such as, for example, imaging, imposition and/or product structure data for each printing order, by way of which more flexible production planning is made possible, which leads to a faster production process.

A print form-variable production device according to the present invention can comprise both a printing press with one or multiple integrated further processing devices and also a printing press and one or further modular, i.e., non-integrated components, which serve as further processing devices. In the printing press, one or multiple paper webs or paper sheets are printed in accordance with the present orders, which are stored in a storage device and subsequently passed on to a further processing device. Here, a production process comprises multiple orders and each order can differ from the previous one.

A storage device according to the present invention can comprise any device for storing information. The storage device can either be integrated in one of the production devices or be otherwise available, for example, via a network connection and suitable interfaces, and is known from the prior art. The storage device can make available the stored data by way of, for example, interfaces of other production machines. The data format can also be converted into a format that is suitable for the respective production machine. The storage device can store any product data made available, for example, the imaging, imposition and product structure data and make these available to each of the production devices if required.

Further processing devices according to the present invention are all devices which make possible further processing of the substrate coming from the printing press, be it as a paper web or as sheets or in any other possible format. These include among others one or multiple cutting, folding, punching, sectioning, collecting, separating and/or stitching devices or a combination thereof. Further processing is to mean any further processing of the substrate coming from the printing press, that is, for example, the cutting, folding, collecting, gluing, sectioning, perforating, separating, joining, book-block binding and/or passing on to the next further processing device etc.

The scanning device according to the present invention can either be integrated before or in the further processing device or can be made available modularly. The scanning device scans at least a part of the print image of the substrate, which was created by the printing press and passed on.

For scanning the print image of each order, different methods and devices can be used depending on the scanning device employed. For example, only one or multiple predefined parts of the printing image of an order can be scanned. Such a part can, for example, be a predetermined region which has the features that are characteristic of the corresponding printing order, e.g., geometrical data. Multiple regions can also be scanned at the same time. The regions can, for example, be a single or multiple tracks or trails or predefined regions of the individual order or a combination thereof. The regions can differ for each order. Scanning can be effected by a sensor or another suitable scanning device. The print image can be scanned pixel-accurately or in any desired resolution, depending on which scanning device is used. Scanning can also be carried out in that a histogram of multiple predefined features is created, for example by an image or colour histogram, which are known from digital photography. One or multiple predetermined features such as, for example, individual colours or multiple colours, among them also white and black, can be sensed. A combination of, for example, the colour scanning for a region and a pixel-accurate scanning for a further region can also take place. This can, for example, be advantageous for scanning book pages, which differ mainly in the page numbering. The scanning possibilities described here, however, are not restricted. Any method for scanning the print image can rather be used for as long as it satisfies the requirements with respect to the needed information, that is, for example, resolution. Methods such as re-photographing or a scanning of the print image by lines as known, for example, also from image processing are also conceivable.

Once the scanning device has scanned the print image, the scanned print image is compared with the product data known for each order and already stored for the printing, such as, for example, the image data or digital printing data in order to assign the appropriate order to the printing image. The comparison is performed by known comparison devices and is dependent on how the printing image was scanned. For example, an image-image comparison can take place during which the entire print image is compared with the imaging data. However, the histogram can also be compared with the imaging data when these are available in the same format or converted into the same. The comparison is also dependent on the computer output and the data to be compared and is selected so that high efficiency and the required accuracy can be attained.

Once the relevant order has been assigned to the respective print image the product data corresponding to the order, in particular the imposition and product structure data, are likewise assigned to the print image so that from these the subsequent control actions corresponding to the order can be assigned and carried out.

The product data are preferably stored in the same storage device but are not restricted to the same. The product data can be provided in a format that can be directly used or can be converted into a suitable format.

In addition, a print form-variable device is provided according to the present invention, which carries out the method described above. This device comprises at least the devices described above for the method such as, for example, a printing press, a scanning device, a storage device and a further processing device. Further devices, which are required in order to carry out a printing process at a print form-variable production device are known to the person skilled in the art and are not mentioned here.

In the following, the invention is explained in more detail with the help of the attached drawings, which merely represent an exemplary embodiment.

### BRIEF DESCRIPTION OF THE DRAWINGS

FIG. 1 illustrates a structure in principle of a production device with a printing press having an integrated further processing device;

FIG. 2 is an enlarged view of the scanning device and the print image to be scanned; and

FIG. 3 illustrates possible regions of a printed paper web to be scanned.

### DETAILED DESCRIPTION OF THE DRAWINGS

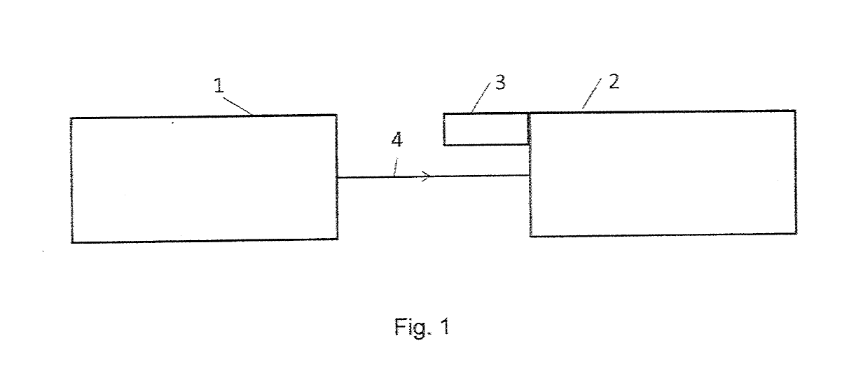

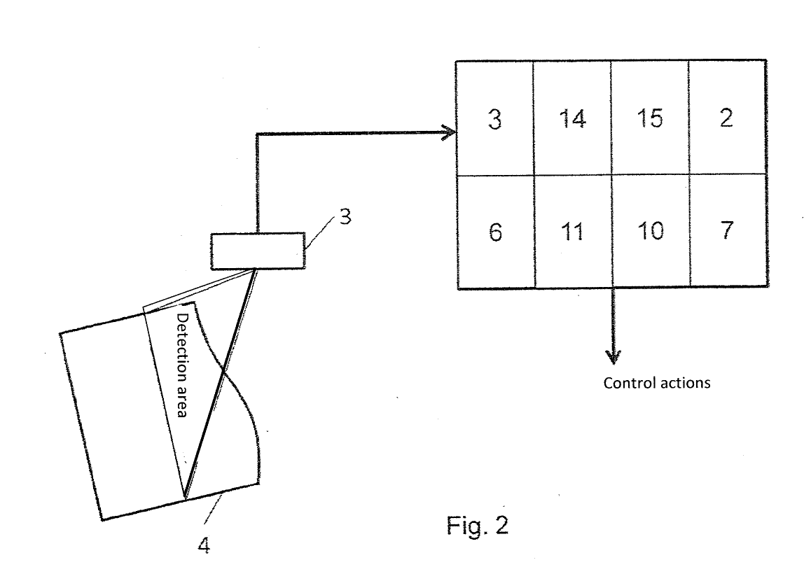

Shown and described with reference to FIG. 1 is a production device with a printing press 1 with an integrated further processing device 2. In addition, FIG. 2 shows a scanning device 3, which scans a print image of the substrate 4 coming from the printing press, for example, printed paper web(s) or paper sheets. The substrate 4 directed to the further processing device 2 is printed in the printing press 1 according to the existing orders and imaging data provided for the respective order, i.e., the digital printing data. The imaging data are known for each order and stored in a storage device (not shown). By way of a scanning device 3 the substrate 4 is directed to the further processing device 2 and further processed there according to the control actions determined for the respective order.

FIG. 2 is an enlarged view of the scanning device 3 and of the print image 4 to be scanned. The scanning device 3 scans at least a part of the substrate 4 before the same reaches the further processing device 2. The scanned print image is compared with the imaging data which are stored for each order. By way of this comparison, the associated order and thus the matching imposition and product structure data can be assigned to the print image. By assigning to the matching order, the subsequent control actions can be determined for the respective order and carried out in the further processing device 2.

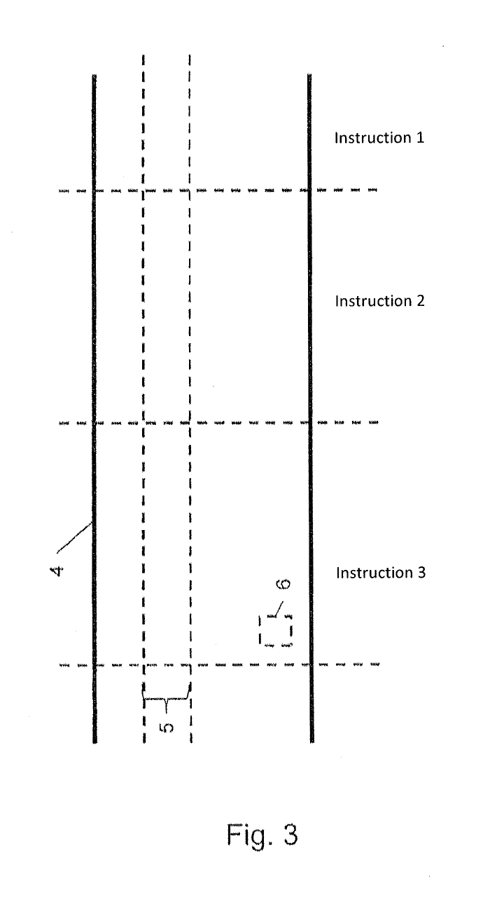

FIG. 3 shows an exemplary view of possible regions to be scanned. Individual tracks 5 or predetermined regions 6 or a combination thereof, for example, regions in which page numbers or other characteristic features are present, can be scanned. This scanning is preferentially carried out in a high-resolution manner, preferably pixel-accurately since scanning of the image content is desired here in order to achieve an unambiguous assignment. In the example shown here, scanning is performed only on one side of the substrate. However, this is not limited. On the contrary, scanning can also be performed on one or multiple pages, e.g., in the case of paper webs or sheets from the top and bottom.

The invention overcomes the initially described disadvantages by providing the method described above and a device for the scanning of a print image without marks. Further advantages are the possibility of carrying out a quality check of the resulting product even in the production device by using a scanning device and, for example, carrying out a completeness check or achieve recognition of impositions.

### LIST OF REFERENCE NUMBERS

1 Printing press

2 Further processing device

3 Scanning device

4 Paper webs or paper sheets

5 Individual tracks

6 Predetermined regions

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling or regulating a production process in a print form-variable production device, wherein the production process comprises one or a plurality of orders and wherein for each of the orders corresponding product data are stored in a storage device, comprising the steps of:
a. scanning a print image by a scanning device of at least one part of a substrate to produce a scanned print image;
b. comparing the scanned print image with the product data stored for each of the orders and assigning an associated order and associated product data of the associated order to the scanned print image based on the comparing;
c. determining subsequent control actions from the associated product data; and
d. executing the subsequent control actions by the production device.

2. The method according to claim 1, wherein the product data comprises imaging data, imposition layouts, and/or product structure data.

3. The method according to claim 2, wherein the product structure data comprises information regarding a logical structure, a content, personalizations of a product, logistical information, and commercial information.

4. The method according to claim 1, wherein no marks associated with the subsequent control actions are provided on the substrate.

5. The method according to claim 1, wherein an entire print image of the substrate is scanned.

6. The method according to claim 1, wherein at least one predetermined track of the print image of the substrate is scanned.

7. The method according to claim 1, wherein step a is performed at least on one side of the substrate.

8. The method according to claim 1, wherein the substrate is a web-like substrate or a sheet-like substrate.

9. The method according to claim 8, wherein the web-like substrate is a paper web and wherein the sheet-like substrate is a paper sheet.

10. The method according to claim 1, wherein step a is performed by a sensor.

11. The method according to claim 1, wherein the print image is scanned pixel-accurately.

12. The method according to claim 1, wherein the print image is scanned such that substantial geometric features are scanned.

13. The method according to claim 1, wherein the print image is scanned such that a histogram regarding one or a plurality of predetermined features is created.

14. The method according to claim 13, wherein the one or the plurality of predetermined features includes the colours white, black, blue, yellow, red and/or green.

15. The method according to claim 13, further comprising the step of pixel-accurate scanning of a further feature of the print image.

16. The method according to claim 1, wherein the subsequent control actions include cutting, collecting, perforating, folding, sectioning, separating, gluing, punching, forming book-blocks, and/or passing on to a following processing device.

17. A print form-variable production device, comprising:
a scanning device, wherein the scanning device scans a print image of at least one part of a substrate to produce a scanned print image;
wherein the production device compares the scanned print image with respective product data stored for one or a plurality of orders of a production process to assign an associated order and associated product data of the associated order to the scanned print image;
wherein the production device determines subsequent control actions from the associated product data;
and wherein the production device executes the subsequent control actions.
